(19) United States
(12) Patent Application Publication
(10) Pub. No.: US 2011/0089202 A1
(43) Pub. Date: Apr. 21, 2011

(54) PAPER HANGER ASSEMBLIES AND ASSOCIATED METHODS OF USE AND MANUFACTURE

(76) Inventors: Bijan Pakzad, Issaquah, WA (US); Christine McAdam, Redondo Beach, CA (US)

(21) Appl. No.: 12/582,645

(22) Filed: Oct. 20, 2009

(51) Int. Cl. A41D 27/22; B32B 37/16

(52) U.S. Cl. 223/85; 156/245

(57) ABSTRACT

The present disclosure relates generally to hangers, and more particularly to hangers that are produced from biodegradable materials and that have a three-dimensionally contoured shape. One such hanger can include a body having a hook portion extending away from first and second shoulder portions. At least one of the hook portion and the first and second shoulder portions can include a cavity therein.

### TECHNICAL FIELD

The present disclosure is directed generally to hangers and, more specifically, to hangers that are produced from biodegradable materials and that have a three-dimensionally contoured shape defining one or more cavities.

### BACKGROUND

Hangers are frequently used to hang or otherwise suspend various types of clothing. For example, hangers are often used in the home to hang different types of garments, such as shirts, pants, skirts, jackets, dresses, etc. Hanging clothing on a hanger provides several advantages over folding and storing clothing in a drawer or on a shelf. For example, clothing that is hung on a hanger is easily identifiable and accessible. Hanging clothing on a hanger can also prevent the clothing from becoming wrinkled. Hangers are also used extensively in retail applications. For example, retail stores often display various types of clothing on hangers to organize or categorize the clothing, and to allow shoppers to easily browse the inventory. Moreover, retail stores also frequently store the inventor on hangers to allow large quantities of the inventory to be quickly and easily moved from one location to another.

### BRIEF DESCRIPTION OF THE DRAWINGS

FIG. 1A is a front view of a hanger configured in accordance with an embodiment of the disclosure.

FIG. 1B is a front view of the hanger of FIG. 1A in a partially assembled condition.

FIG. 2A is an enlarged cross-sectional side view taken substantially along the lines 2A-2A of FIG. 1.

FIG. 2B is an enlarged cross-sectional side view taken substantially along the lines 2B-2B of FIG. 1.

FIG. 2C is an enlarged cross-sectional side view taken substantially along the lines 2C-2C of FIG. 1.

FIGS. 3A and 3B are isometric views of the hanger of FIG. 1.

FIG. 4 is a front view of a hanger configured in accordance with another embodiment of the disclosure.

FIG. 5 is a front view of a hanger configured in accordance with yet another embodiment of the disclosure.

FIG. 6 is a front partial view of a hanger configured in accordance with still another embodiment of the disclosure.

### DETAILED DESCRIPTION

Hangers having a three dimensionally contoured shape and that are made from biodegradable materials, and associated methods for using and making such hangers are described in detail herein in accordance with embodiments of the present disclosure. Certain details are set forth in the following description with reference to the Figures to provide a thorough and enabling description of various embodiments of the disclosure. Other details describing well-known structures and components often associated with hangers and methods of forming such assemblies, however, are not set forth below to avoid unnecessarily obscuring the description of various embodiments of the disclosure.

Many of the details, dimensions, angles, relative sizes of components, and/or other features shown in the Figures are merely illustrative of particular embodiments of the disclosure. Accordingly, other embodiments can have other details, dimensions, angles, sizes, and/or features without departing from the spirit and scope of the present disclosure. In addition, further embodiments of the disclosure may be practiced without several of the details described below, while still other embodiments of the disclosure may be practiced with additional details and/or features.

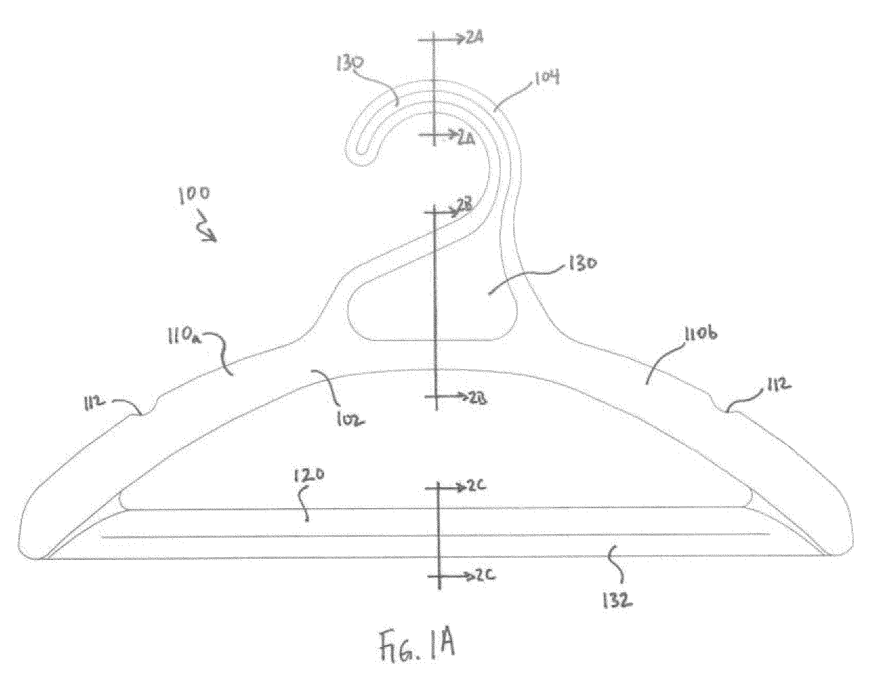

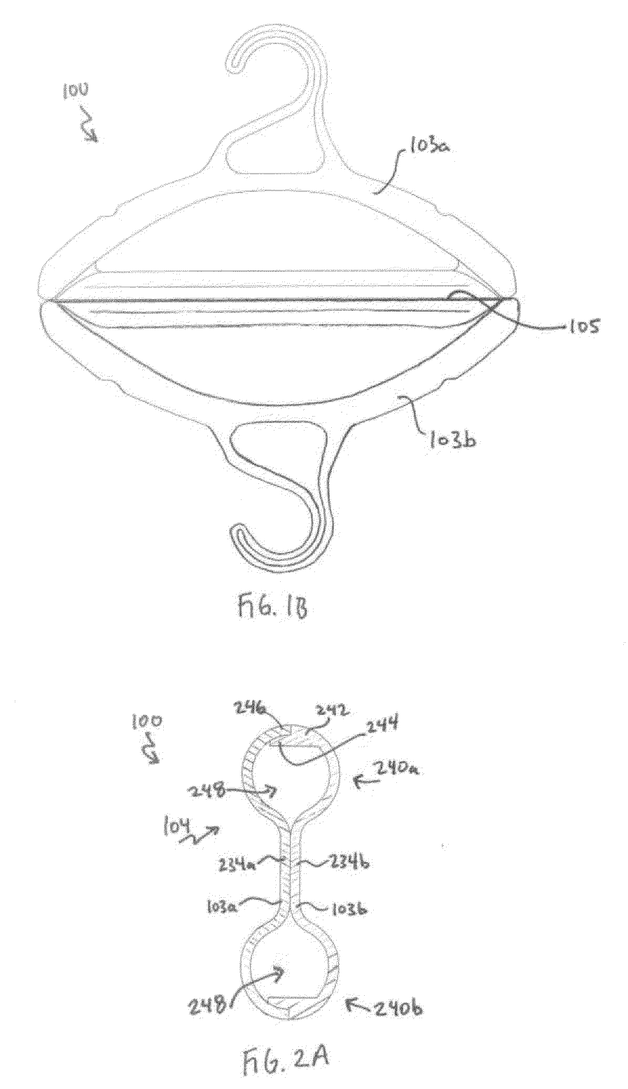

FIG. 1A is a front view of a hanger assembly 100 configured in accordance with an embodiment of the disclosure. In the illustrated embodiment, the hanger 100 includes a frame or body 102 having a three-dimensionally contoured shape. More specifically, the body 102 includes a hook portion 104 extending from shoulder portions 110 (identified individually as a first shoulder portion 110a and a second shoulder portion 110b). The body 102 can further include several features to facilitate hanging different types of clothing. For example, each shoulder portion 110 can include a recess 112 that is configured to at least partially receive or retain part of an article of clothing that is positioned on the hanger 100. Although the recesses 112 illustrated in FIG. 1A have a relatively shallow, U-shaped configuration, in other embodiments the recesses 112 can include other suitable shapes, including for example, deeper groove or hooks. The recesses 112 can also be omitted. The body 102 can also include a pant portion or rod 120 spanning or extending between the shoulder portions 110 to facilitate hanging pants, skirts, or other types of clothing from the hanger 100. Moreover, as will be appreciated by one of ordinary skill in the art, the body 102 can include any configuration or other feature suitable for hanging various types of clothing.

According to one feature of the illustrated embodiment, the hanger 100 is made from a biodegradable material, such as paper. More specifically, and as described in detail below, the hanger 100 can be made from a molded paper or pulp. Such molded paper can include, for example, pulp paper, pulp fiber, foamed paper pulp, recycled newspaper, brown paper, white paper, sugar cane pulp, bamboo pulp fibers, and/or any other suitable biodegradable material. These materials can be recycled materials, and can also be recycled again after use. In addition, the hanger 100 can be formed with these materials by vacuum forming, molding with any of type 2, 3, or 4 molding processes, pressing, and any other suitable forming technique to achieve the desired structural and aesthetic characteristics described herein. In addition, the exterior and/or interior surfaces of these biodegradable materials can be treated with a secondary process such as with a coating or by pressing to achieve the desired structural and aesthetic features described herein.

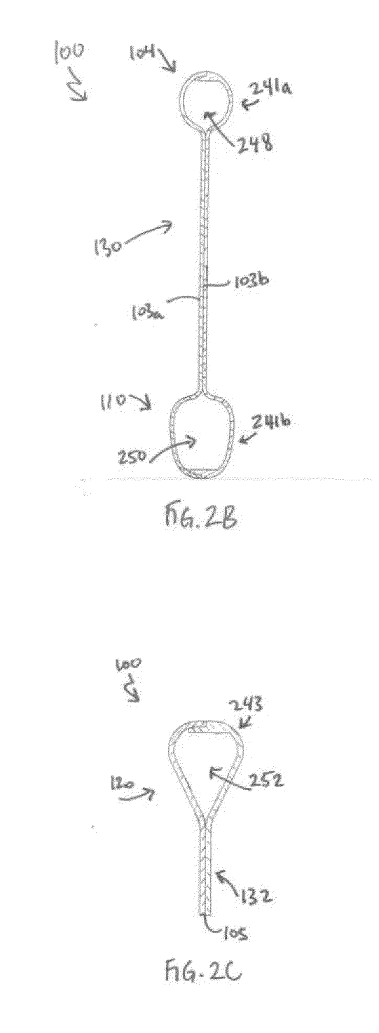

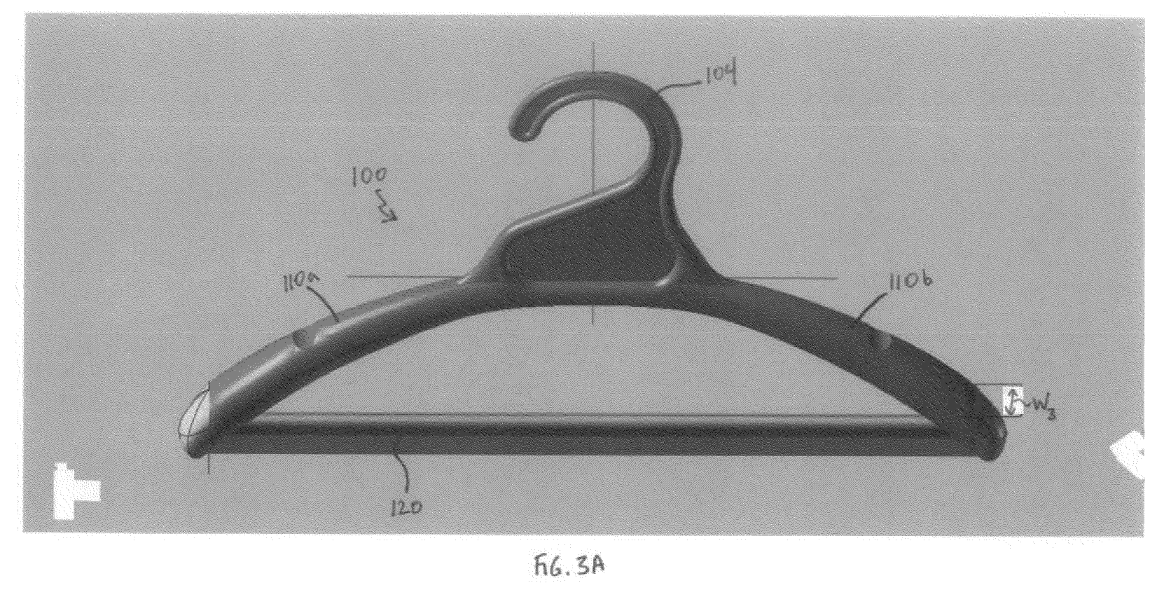

According to another feature of the illustrated embodiment, the hanger 100 can be made from two or more contoured pieces that are coupled together to form at least one cavity therebetween. As shown FIG. 1B, for example, which is a front view of the hanger 100 in a partially assembled condition, the hanger 100 includes a first half 103a opposite a second half 103b. In the illustrated embodiment, the first half 103a and the second half 103b are mirror images of each other and are joined together along a fold line 105 in a hinged or clam-shell type configuration. Accordingly, the hanger 100 can be assembled by folding the first half 103a towards the second half 103b along the fold line 105. In other embodiments, however, the first half 103a can be a separate piece from the second half 103b. In either case, and as described in detail below with reference to FIGS. 2A-2C, the first half 103a can be bonded to the second half 103b with an adhesive or by other suitable methods for joining the two halves 103a, 103b.

Referring again to FIG. 1A, the body 102 includes several reinforcement or bonding regions to attach the first half 103a to the second half 103b (FIG. 1B). Although these features are described with reference to FIG. 1A in which only one half of the hanger 100 is visible, it will be appreciated that each of the first and second halves 103a, 103b can include these features. For example, the body 102 includes a first bonding portion 130 extending between the shoulder portions 110 and along the hook portion 104. The body 102 also includes a second bonding portion 132 extending adjacent to the rod portion 120. As described below, these bonding portions provide strengthened areas where the first and second halves 103a, 103b can be securely attached or bonded to one another with an adhesive. In the illustrated embodiment, the first bonding portion 130 and the second bonding portion 132 are generally planar regions of the body 102 that are adjacent to or surrounded by three-dimensionally contoured portions of the hanger 100. Moreover, the first bonding region 130 can also display a logo, advertisement, or other graphical or textual representation.

FIG. 2A is an enlarged cross-sectional side view of the hanger 100 taken substantially along the lines 2A-2A of FIG. 1. FIG. 2A illustrates how the first half 103a is adhered or otherwise joined to the second half 103b to form the hook portion 104. More specifically, according to one feature of the illustrated embodiment the first half 103a is joined to the second half 103b at the planar first bonding portion 130. For example, a generally flat or planar first segment 234a of the first half 103a is attached to a corresponding flat or planar second segment 234b of the second half 103b at the first bonding portion 130. The first and second segments 234a, 234b provide a relatively large surface area for bonding with an adhesive. In one embodiment, the first and second segments are configured to engage each other via a lap joint. In other embodiments, the segments engage each other in a butt-joint, although other joining configurations can be used. The first and second segments 234a, 234b structurally enhance the body 102 to provide strength and rigidity to the hook portion 104. More specifically, the first and second segments 234a, 234b provide a reinforced transition from the hook portion 104 to the shoulder portions 110 that is configured to withstand the typical impact and/or weight encountered during use of the hanger 100. In one embodiment, all or a portion of the hook portion can be integrally connected to one or both of the first and second segments. In other embodiments, the hook can be a separate component joined the first and/or second segments. The hook can be made of the same material as the hanger's first and second segments. In other embodiments, the hook can be made of other material, such as paper, pulp, metal, wood, plastic, or other suitable material.

According to another feature of the illustrated embodiment, the first half 103a is also joined to the second half 103b along an outer periphery of contoured portions 240 (identified individually as an upper or first contoured portion 240a and a lower or second contoured portion 240b) of the hook portion 104. More specifically, and with reference to the first contoured portion 240a, the second half 103b includes a reinforced portion 242 at an outer peripheral region of the hook portion 104. The reinforced portion 242 has a relatively larger cross-sectional thickness than the rest of the hook portion 104. More specifically, the reinforced portion 242 has a stepped configuration or shape with an extension 244 projecting therefrom. In this manner, the reinforced portion 242 is configured to receive a corresponding end portion 216 of the first half 103a at the outer peripheral region to attach or otherwise bond the first half 103a to the second half 103b. The second contoured portion 240b has the same general configuration as the first contoured portion 240a. As such, each of these contoured portions 240 forms a hook portion cavity 248 adjacent to and/or at least partially surrounding the first bonding portion 130. In the illustrated embodiment, the hook portion cavity 248 has a generally circular cross-sectional shape. In other embodiments, however, and as described below, other portions of the hanger 100 can have cavities with different cross-sectional shapes.

FIG. 2B is an enlarged cross-sectional side view of the hanger 100 taken substantially along the lines 2B-2B of FIG. 1. FIG. 2B illustrates several features of the hanger 100 that are generally similar in structure and function to the corresponding features described above with reference to FIG. 2A. For example, as shown in FIG. 2B the first bonding portion 130 extends between a first contoured portion 241a of the hook portion 104 and a second contoured portion 241b of the shoulder portion 110. Moreover, each of the first and second contoured portions 241a, 241b can include a reinforcement portion for bonding the first half 103a to the second half 103b at an outer peripheral region of the hook portion 104 and the shoulder portion 110. In addition, the first contoured portion 241a includes the hook portion cavity 248 adjacent to the first bonding portion 130, and the second contoured portion 241b also includes a shoulder portion cavity 250 adjacent to the first bonding portion 130. In certain embodiments, the hook portion cavity 248 can be in fluid communication with the shoulder portion cavity 250. In other embodiments, however, these cavities can be separate from each other and not connected. Moreover, in the illustrated embodiment, the shoulder portion cavity 250 has a generally elliptical or ovoid shape. However, as will be appreciated by one or ordinary skill in the art, the shoulder portion cavity 250 extends longitudinally along the corresponding shoulder portion 110 (FIG. 1A). Accordingly, the cross-sectional shape of the shoulder portion cavity 250 varies along the longitudinal position of the corresponding shoulder portion 110.

FIG. 2C is an enlarged cross-sectional side view of the hanger 100 taken substantially along the lines 2C-2C of FIG. 1A. FIG. 2C also illustrates several features of the hanger 100 that are generally similar in structure and function to the corresponding features described above with reference to FIGS. 2A and 2B. For example, as shown in FIG. 2C the rod portion 120 includes a contoured portion 243 including a reinforcement portion similar to the reinforcement portions described above. Moreover, the first contoured portion 243 defines a rod portion cavity 252 adjacent to the second bonding portion 132. In the illustrated embodiment, the rod portion cavity 252 has a generally triangular or teardrop cross-sectional shape. However in other embodiments, the rod portion cavity 252 can include other shapes.

In certain embodiments, the cavities of the hanger 100 described herein can be hollow cavities. In other embodiments, however, one or more of these cavities can be at least partially filled with various materials. In one embodiment, for example, the cavities can be filled with a scented or fragrant material, such as potpourri, cedar, deodorant, and/or mothballs. In other embodiments, the cavities can be filled with one or more noise-making devices, such as playback devices, bells, or other powered or non-powered items that can be moved or activated to make noise. In another embodiment, the hanger can be provided with a light emitting device that is fully or partially contained in one or both of the cavities. The light emitting device can be configured to be activiated manually, such as by an on-off switch. In another embodiment, the light emitting device can be activated automatically, such as by using a motion detection system or other system that can activate the light in response to a selected action or condition. The hanger can be constructed with a translucent or event transparent portion through which light from the light emitting device can pass so as to be visable to a user.

In another embodiment, the cavities can be at least partially filled with a stiffening or strengthening material to improve the structural integrity and/or rigidity of the hanger 100. The strengthening material can be the same material as the body 102 of the hanger, or the strengthening material can be a different material. In still further embodiments, the cavities can be molded to include core ribbing in the sidewalls of the cavities to improve the strength of the hanger. Moreover, a coating, such as a biodegradable coating, can be applied to the interior surfaces of the cavities to strengthen or stiffen the sidewalls of the cavities.

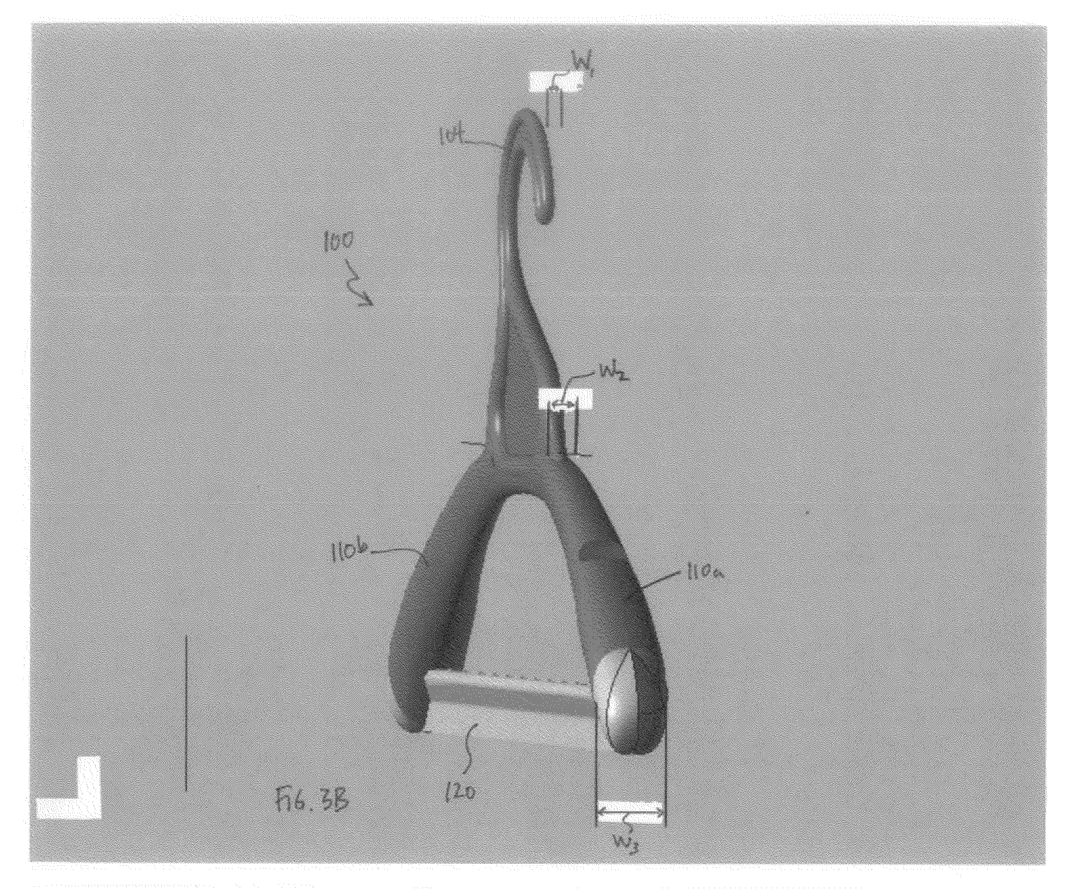

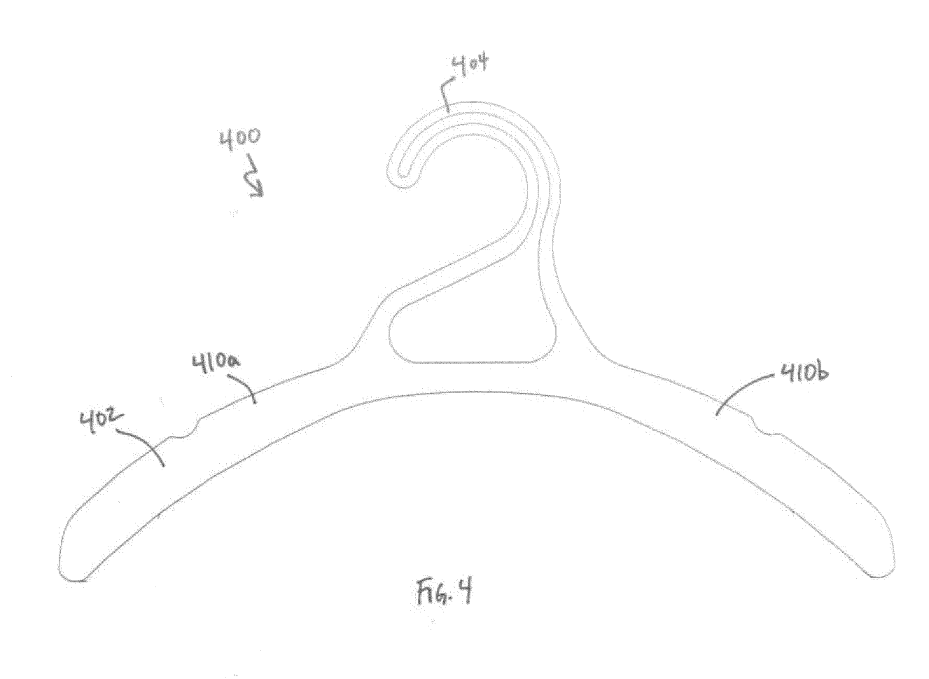

FIG. 3A is a front isometric view and 3B is a side isometric view of the hanger 100 further illustrating the three-dimensionally contoured shape of the hanger 100. Referring to FIGS. 3A and 3B together, the contoured shape of the hanger 100 includes several non-planar regions or portions as described in detail below. For example, and referring to FIGS. 3A and 3B together, the hook portion 104 can have a first width W₁ of approximately 6 mm, the shoulder portions 110 can have a second width W₂ of approximately 12 mm at the transition from the hook portion 104, and the shoulder portions 110 can have a third width W₃ of approximately 30 mm at the widest region of the shoulder portions 110 opposite the hook portion 104. Moreover, the rod portion 120 can have a width of approximately 10 mm. In other embodiments, however, these components of the hanger 100 can have dimensions that are greater than or less than the dimensions listed above. Moreover, in still further embodiments the hanger 100 can have a generally uniform width.

The three-dimensionally contoured shape of the various portions of the hanger 100 provides several advantages. For example, the contoured shape of the hook portion 104 provides a rounded surface that is comfortable for a user's hands. This contoured shape also provides an increased surface area of the hook portion 104 to distribute the pressure and/or impact when a user positions the hanger 100 on a clothing rod. Moreover, the contoured shape of the shoulder portions 110 provides a relatively wide surface for clothing to rest on to avoid stretching the clothing with the hanger 100.

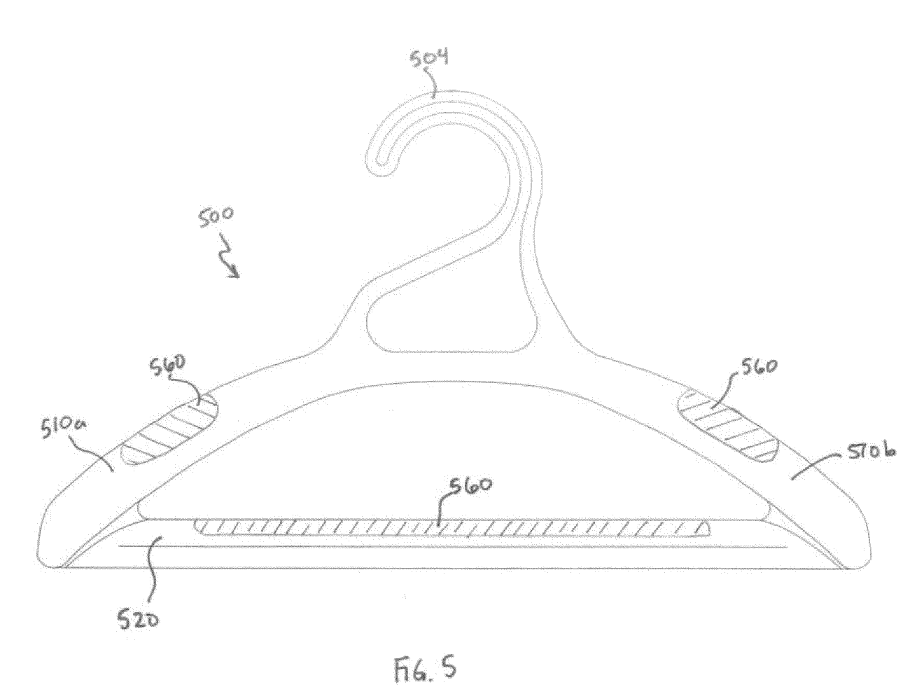

FIG. 4 is a front view of a hanger 400 configured in accordance with another embodiment of the disclosure. The hanger 400 includes several features that are generally similar in structure and function to the corresponding features of the hanger 100 described above with reference to FIGS. 1A-3B. For example, the hanger 400 includes a body 402 having a hook portion 404 extending from shoulder portions 410 (identified individually as a first shoulder portion 410a and a second shoulder portion 410b). In the illustrated embodiment, however, the hanger 400 does not include a pant rod extending between the shoulder portions 410.

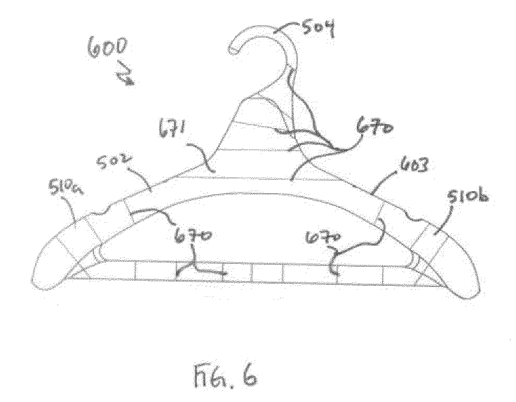

FIG. 5 is a front view of a hanger 500 configured in accordance with yet another embodiment of the disclosure. The hanger 500 includes several features that are generally similar in structure and function to the corresponding features of the hangers 100, 400 described above with reference to FIGS. 1A-4. For example, the hanger 500 includes a body 502 having a hook portion 504 extending from shoulder portions 510 (identified individually as a first shoulder portion 510a and a second shoulder portion 510b). In the illustrated embodiment, however, each of the shoulder portions 510, as well as the rod portion 520, includes a textured region 560. The textured regions 560 are configured to provide a non-slip area of the hanger 500 so that clothing does not slide off of the hanger 500. The textured regions 560 are configured to have a generally rough texture, while the remainder of the body 502 can have a generally smooth texture.

In some embodiments, the textured regions 560 can be formed in a molding process by molding different exterior surface treatments on the body 502 at the textured regions 560. For example, when the hanger 500 is formed from biodegradable molded paper, the body 502 can undergo a secondary molding process (e.g., type 2, type 3, and/or type 4 paper molding processes) to provide the desired texture at the textured regions 560. In other embodiments, the body 502 can be impregnated with a second material (e.g., rubber) thereby providing the desired texture at the textured regions 560. Moreover, in still further the textured regions 560 can be adhered to the body 502.

FIG. 6 is a front partial view of an inner core or interior surface 671 of one half 603 of a hanger 600 configured in accordance with yet another embodiment of the disclosure. The hanger 600 includes several features that are generally similar in structure and function to the corresponding features of the hangers 100, 400, 500 described above with reference to FIGS. 1A-5. For example, the hanger 600 includes a body 602 having a hook portion 604 extending from shoulder portions 610 (identified individually as a first shoulder portion 610a and a second shoulder portion 610b). In the illustrated embodiment, however, the hanger 600 includes several stiffening ribs 670 extending across the interior surface 671. In certain embodiments, the stiffening ribs 670 can be integrally molded or formed on the interior surface 671. In other embodiments, however, the stiffening ribs 670 can be separate pieces that are attached to the interior surface 671. In either case, the stiffening ribs 670 are configured to improve the stiffness, strength, and/or rigidity of the hanger 600.

From the foregoing, it will be appreciated that specific embodiments have been described herein for purposes of illustration, but that various modifications may be made without deviating from the spirit and scope of the disclosure. For example, a hanger as described herein can include portions or pieces made from different materials than the body of the hanger and that are separately attached to the body of the hanger. For example, the hook portion can be made from a separate material than the body of the hanger. Moreover, aspects described in the context of particular embodiments may be combined or eliminated in other embodiments. Further, although advantages associated with certain embodiments have been described in the context of those embodiments, other embodiments may also exhibit such advantages, and not all embodiments need necessarily exhibit such advantages to fall within the scope of the disclosure.

I/We claim:

1. A hanger comprising:
a body made from a biodegradable material, wherein the body has a generally planar portion and further comprises:
a first shoulder portion having first contoured shape defining a first cavity adjacent to the planar portion;
a second shoulder portion opposite the first shoulder portion, wherein the second shoulder portion has a second contoured shape defining a second cavity adjacent to the planar portion; and
a hook portion extending from the first and second shoulder portions, wherein the hook portion has a third contoured shape and includes a third cavity adjacent to the planar portion.

2. The hanger of claim 1 wherein each of the first and second shoulder portions and the hook portion is an integral piece of the body.

3. The hanger of claim 1 wherein each of the first cavity, the second cavity, and the third cavity is hollow.

4. The hanger of claim 1 wherein the biodegradable material is a first material, and wherein at least one of the first cavity, the second cavity, and the third cavity is at least partially filled with a second material different than the first material.

5. The hanger of claim 1 wherein the each of the first and second cavities extends longitudinally along the corresponding first and second shoulder portions.

6. The hanger of claim 1 wherein the third cavity extends generally around an outer peripheral region of the hook portion.

7. The hanger of claim 1 wherein the planar portion extends through a central region of the hook portion, and wherein the third cavity extends along a peripheral region of the hook portion and at least partially surrounds the planar portion.

8. The hanger of claim 1 wherein the body further comprises a first half that is joined to a second half, and wherein the joined first and second halves define each of the planar portion, the first shoulder portion, the second shoulder portion, and the hook portion.

9. The hanger of claim 8 wherein the first half is attached to the second half with an adhesive at the planar portion and along at least a portion of an exterior periphery of the body.

10. The hanger of claim 1 wherein at least a segment of the exterior periphery of the body includes a reinforcement portion having a first cross-sectional thickness that is greater than a second cross-sectional thickness of the body spaced apart from the reinforcement portion.

11. A hanger made from a biodegradable material, the hanger comprising:
a first half comprising—
a first shoulder portion; and
a first hook portion extending away from the first shoulder portion;
a second half comprising—
a second shoulder portion that corresponds to the shape of the first shoulder portion; and
a second hook portion extending away from the second shoulder portion, wherein the second hook portion corresponds to the shape of the first hook portion;
wherein the first half is coupled to the second half around at least a portion of an outer periphery of the first and second halves, and wherein the attached first and second halves define a cavity therebetween.

12. The hanger of claim 11 wherein:
the first half further comprises a first generally planar portion; and
the second half further comprises a second generally planar portion that corresponds to the shape of the first planar portion and that is attached directly to the first planar portion with an adhesive.

13. The hanger of claim 12 wherein:
the first planar portion extends through at least a portion of the first shoulder portion and the first hook portion; and
the second planar portion extends through at least a portion of the second shoulder portion and the second hook portion.

14. The hanger of claim 12 wherein the cavity extends around the attached first and second planar portions.

15. The hanger of claim 11 wherein:
the first half further comprises a first rod portion spanning the first shoulder portion; and
the second half further comprises a second rod portion spanning the second shoulder portion, wherein the second rod portion corresponds to the shape of the first rod portion;
wherein the cavity is a first cavity between at least one of the first and second shoulder portions and the first and second hook portions, and wherein the attached first and second halves further define a second cavity between the first and second rod portions.

16. The hanger of claim 11 wherein the first half is attached to the second half with an adhesive.

17. The hanger of claim 11 wherein the biodegradable material is a first material and wherein the cavity is at least partially filled with a second material that is different from the first material.

18. The hanger of claim 11 wherein a region of an exterior surface of at least one of the first shoulder portion and the second shoulder portion has a first texture, and wherein a remainder of the exterior surface has a second texture that is different from the first texture.

19. The hanger of claim 18 wherein the second texture is smoother than the first texture.

20. A method of manufacturing a hanger made from a biodegradable material, the method comprising:
molding a first half of the hanger, wherein the first half includes a first hook portion extending from a first shoulder portion;
molding a second half of the hanger, wherein the second half includes a second hook portion extending away from a second shoulder portion, wherein the shape of the second half corresponds to the shape of the first half; and
coupling the first half to the second half thereby defining an enclosed cavity in the hanger between the first hook portion and the second hook portion and between the first shoulder portion and the second shoulder portion.

21. The method of claim 20 wherein:
molding the first half further comprises molding the first half with a first rod portion spanning the first shoulder portion;
molding the second half further comprises molding the second half with a second rod portion spanning the second shoulder portion; and
wherein the cavity is a first cavity and coupling the first half to the second half further defines a second enclosed cavity between the first rod portion and the second rod portion.

22. The method of claim 20 wherein:
molding the first half further comprises molding the first half with a first generally planar portion;
molding the second half further comprises molding the second half with a second generally planar portion, wherein the shape of the second planar portion corresponds to the shape of the first planar portion; and
coupling the first half to the second half comprises bonding the first planar portion to the second planar portion and bonding an outer periphery of the first half to an outer periphery of the second half with an adhesive.

23. The method of claim 20 wherein:
molding the first half further comprises forming a first outer periphery of the first half having a reinforced stepped region; and
molding the second half further comprises forming a second outer periphery of the second half that is configured to be received in the reinforced stepped region; and
coupling the first half to the second half comprises bonding the second outer periphery to the reinforced stepped region of the first outer periphery with an adhesive.

24. The method of claim 20 wherein the biodegradable material is a first biodegradable material, and wherein the method further comprises depositing a second material between the first half and the second half in the cavity, wherein the second material is different from the first material.
